(19) United States
(12) Patent Application Publication
(10) Pub. No.: US 2006/0105094 A1
(43) Pub. Date: May 18, 2006

(54) Foaming food-grade lubricant

(75) Inventor: Robert Martin Holdar, Irving, TX (US)

Correspondence Address: LOCKE LIDDELL & SAPP LLP;ATTN: SUE COTT, 2200 ROSS AVENUE, SUITE 2200, DALLAS, TX, 75201-6776, US

(73) Assignee: NCH Corporation

(21) Appl. No.: 10/990,091

(22) Filed: Nov. 16, 2004

(51) Int. Cl. A23D 9/00

(52) U.S. Cl. 426/609

(57) ABSTRACT

A foaming food-grade lubricant that, in a preferred embodiment, includes a blend of triglyceride esters of C₈ to C₂₂ fatty acids derived from vegetable or animal sources compounded with lecithin and, optionally, an organic solvent such as methyl, ethyl or other short chain (<C₈) esters of short-chain carboxylic acids. In general terms, the triglyceride esters provide lubricity to the compositions of the invention, while the lecithin promotes foaming and the optional organic solvent improves the penetration characteristics of the lubricant. If desired, white oil can also be blended into the lubricant. Additional food grade additives can be added to provide improved oxidative stability, lubricity, odor, and other properties. Preferably, the lubricant performs effectively in various food-grade lubrication regimes ranging from hydrodynamic thick films to thin boundary films.

### BACKGROUND OF THE INVENTION

1. Field of the Invention

This invention relates generally to lubricants and, more particularly, to a foaming, penetrating lubricant that lubricates machinery effectively and is also safe for incidental contact with food or beverages.

2. Description of Related Art

Lubricants used in food-processing machinery must be approved by the federal Food and Drug Administration because of the possibility that small amounts of such lubricants will contact the food. Food-grade lubricants must also be used in machines that produce packaging materials for food or beverage products. The U.S. Department of Agriculture (U.S.D.A.) Food Safety Inspection Service formerly certified lubricants suitable for use in food processing and handling plants. In 1999, NSF International launched the NSF Nonfood Compounds Registration and Listing Program to provide an independent certification program to fill the void created by discontinuance of the U.S.D.A. list. All compounds that were on the U.S.D.A. list were carried over to the NSF program.

A satisfactory lubricating oil for use in a food processing facility will preferably lubricate machine parts, resist viscosity changes, resist oxidation, protect against rust and corrosion, provide wear protection, and resist the formation of sludge when in service. Food-grade lubricants that can penetrate rapidly between contacting metallic surfaces that have become rusted, frozen, or otherwise stuck together are also needed. Penetrating lubricants are generally characterized by lower viscosity and surface tension than ordinary lubricants.

One group of food-grade lubricants that are useful with food handling and processing machinery are “white oils.” White oils are characteristically colorless, odorless, and tasteless mineral oils produced by treating light industrial oils with acid and then neutralizing the resultant compositions with a strong base. This removes aromatics and olefins from the oils, resulting in benign oil products that are relatively non-reactive. White oils are widely used in the food, drug, and cosmetic industries because they are non-toxic, inert and non-staining.

Lecithin, a natural product typically obtained from soy, has previously been used to improve the lubrication properties of pure white food-grade mineral oils. Small amounts of vegetable oil are also sometimes added to these mineral oil lubricants to improve lubricity. Various additives have also been disclosed for use in food-grade lubricants to enhance one or more characteristics. Examples of such additives include, for example, antioxidants, anti-wear inhibitors, corrosion inhibitors, pour-point depressants, thickeners, and/or food-grade tackifiers. Anti-foaming agents are often included in food-grade lubricants made of triester oils.

Nonstick cooking sprays are generally viewed as being unacceptable for the lubrication of machinery and are not typically used in that manner. For nonstick cooking sprays, lecithin or ethyl alcohol are sometimes used in combination with vegetable oil and water to serve as an emulsifier and also to suppress foaming. A propellant is provided to dispense the emulsion from an aerosol can.

Some prior art food-grade lubricants for equipment and machinery are disclosed, for example, in U.S. Pat. No. 5,538,654 (hydraulic oil; gear oil; compressor oil) and U.S. Pat. No. 6,087,308 (lubricating oil). Some prior art food-grade lubricants useful as non-stick or release agents for cooking surfaces are disclosed, for example, in U.S. Pat. Nos. 4,073,412; 4,753,742; 5,156,876; 5,370,732; and 5,503,866. Some prior art patents disclosing edible aerosol foams include, for example, U.S. Pat. Nos. 4,639,347; 4,752,465; 4,780,309; and 4,889,709.

U.S. Pat. No. 5,858,933 discloses the combination of a chemically modified lecithin and a fatty acid ester in a lubricant for coating moving webs in high speed printing equipment.

It has also been recognized that lecithin can act as a foaming agent in edible oils, such as corn oil. The combination of lecithin and edible oils has been successfully used to develop edible foams that can be used as a drug delivery device or as a way to mask the taste and sensation of an edible oil, so it can be used as a nutritional supplement. Fatty acid esters have also been recognized as effective foaming agents in this context.

Despite the provision of oil foams for the delivery of pharmaceutical products, it has not been recognized that food-grade foaming lubricants can be made that function effectively as lubricants and penetrants for machinery and equipment in food and beverage processing facilities.

### SUMMARY OF THE INVENTION

The invention disclosed herein is a foaming food-grade lubricant that, in a preferred embodiment, comprises a blend of triglyceride esters of C₈ to C₂₂ fatty acids derived from vegetable or animal sources compounded with lecithin and, optionally, an organic solvent such as methyl, ethyl or other short chain (<C₈) esters of short chain carboxylic acids. In general terms, the triglyceride esters provide lubricity to the compositions of the invention, while the lecithin promotes foaming and the optional organic solvent improves the penetration characteristics of the lubricant. If desired, white oil can also be blended into the lubricant. Additional food grade additives can be added to provide improved oxidative stability, lubricity, odor, and other properties. Preferably, the lubricant performs effectively in various food-grade lubrication regimes ranging from hydrodynamic thick films to thin boundary films.

Foaming food-grade lubricants enable the user to see readily where the lubricant is applied. Because they are typically applied in aerosol form, foaming lubricants are particularly useful for coating machinery such as power transmission chains and other hard to reach components that are difficult to cover and lubricate effectively using conventional products. The preferred foaming food-grade lubricants of the invention persist sufficiently to provide good lubricity even when applied to vertical surfaces. When formulated with methyl and ethyl esters of fatty acids, the subject lubricants also exhibit good penetration, making them effective for penetrating rust and crevices, and for removing nuts and bolts bound by corrosion and other contaminants. The use of food-grade substituents permits use of the resultant lubricant on equipment where there may be incidental contact with food or beverage products or packaging.

### DETAILED DESCRIPTION OF THE PREFERRED EMBODIMENT

Applicant has discovered a foaming lubricant that provides many benefits over conventional food-grade lubricants suitable for use with equipment or machinery where incidental contact with foods or beverages may occur. The foam makes it easy to identify where the lubricant has already been applied, thereby ensuring that sufficient coverage is provided and avoiding wasted lubricant. The foam also helps the lubricant provide better coverage by contacting all portions of the machine part being lubricated. This is especially important where there are mechanical components, such as power transmission chains, that are difficult to completely lubricate using conventional lubricants. The foam also helps the lubricant remain in place on vertical surfaces where conventional spray-on lubricants may drain away quickly. The viscosity of the lubricant preferably ranges from about 20 to about 100 cps. Lubricants having higher viscosities will not flow or penetrate as well; lubricants having lower viscosities will not provide sufficient lubrication for wear prevention and satisfactory release torque.

In a preferred embodiment, the inventive foaming, food-grade lubricants comprise a blend of vegetable oil and triglyceride esters of C₈ to C₂₂ fatty acids derived from vegetable oil or animal products, compounded with lecithin, a propellant and, optionally, an organic solvent. The subject lubricants most preferably comprise from about 5 to about 50 weight percent triglyceride esters of C₈ to C₂₂ fatty acids. Vegetable oils such as, for example, soybean oil, provide improved lubricity over white oils, and also exhibit good viscosity and relatively high flash points. Transesterification of such triglycerides with methanol provides the corresponding methyl esters of these fatty acids for use as lubricants. Examples of particularly preferred triglyceride esters for use in the invention include methyl laurate, soy methyl ester and palm methyl ester. Because oils having a high mono-unsaturation content can stiffen at low temperatures, pour-point depressants such as an alkylated polystyrene or a polyalkyl methacrylate can be added to improve flow under low-temperature conditions.

The triglyceride esters are desirably blended with from about 30 to about 87 weight percent vegetable oil, animal products, or mixtures thereof. The oil products used in the invention must provide acceptable lubricity for the particular application, must be food-grade, must be foamable, and must be compatible so that the resultant lubricant is shelf-stable. Vegetable oils suitable for use in the invention are preferably selected from the group consisting of canola oil, corn oil, castor oil, soybean oil, jojoba oil, safflower oil, sunflower oil and palm oil, with canola oil and corn oil being particularly preferred. In place of all or a portion of the vegetable oil component of the invention, animal products such as tallow oil, lard oil, sperm oil, and mixtures thereof, can likewise be used in the foaming, food-grade lubricants of the invention. Similarly, some white mineral oil can be substituted for an equivalent percentage of vegetable oil in the blended lubricant if desired, although lubricity can be adversely affected by the use of too much white oil. The use of more triglyceride ester in the subject compositions may be needed for additional lubricity if white oil is substituted for a significant portion of the vegetable oil component.

Foamability in the subject lubricants is preferably achieved by blending into the lubricant from about 2 to about 12 weight percent lecithin, with about 8 weight percent lecithin being particularly preferred. The amount and quality of the foam is generally proportional to the amount of lecithin used. The lecithin emulsifier used in the current invention should be food grade and is commercially available from many suppliers. There is no need for the lecithin to be chemically modified, although it should not contain an anti-foaming agent. One such product suitable for use in the invention is LECISOY® N1 Soy Lecithin produced by Riceland Foods, Inc. of Stuttgart, Ark. 72160.

Higher penetration properties can be created in the food-grade lubricant of the invention by blending an optional organic solvent into the triglyceride oil. In general, the use of a food-grade organic solvent lowers the viscosity and surface tension of the lubricant, thereby increasing its penetration and climbing abilities. In this case, the triglyceride oil provides the lubricating function and the organic solvent enhances the penetrating ability of the lubricant, assisting for example in the separation of components that have become bound by corrosion, other contaminants, or otherwise frozen together. Organic solvents selected from the group consisting of esters of short-chain carboxylic acids are preferred for this use, and esters of short-chain carboxylic acids having fewer than 8 carbon atoms are particularly preferred. Organic solvents selected from the group consisting of ethyl lactate, ethyl acetate and t-butyl acetate, for example, are satisfactory for use in the foaming, food-grade lubricants of the invention. The amount of organic solvent preferably ranges from about 10 to about 20 weight percent of the lubricant, with about 15 to 17 weight percent being most preferred. Because higher solvent levels increase the penetration ability of the lubricant but also decrease the lubricity, the amount of solvent used can be adjusted to achieve the balance between lubrication and penetration that is desired for a particular application. The use of more than about 20 percent organic solvent can make the product too thin and lower the flash point to an undesirable level. The use of less than about 10 percent organic solvent can reduce penetration to an undesirable extent. The foaming, penetrating lubricant disclosed herein desirably provides improved contact when applied to vertical surfaces and does not drain away as quickly as conventional non-foaming penetrating lubricants.

In addition to the foregoing components, other known food-grade additives can also be included in the foaming, food-grade lubricants of the invention to improve the corrosion resistance, oxidative stability, lubricity, and other properties of the lubricant if desired. For example, a minor effective amount up to about 1 weight percent, and preferably about 0.5 weight percent, of a commercially available, food-grade polysorbate can be added as a surfactant to the inventive compositions. Also, a minor effective amount up to about 1 weight percent antioxidant such as butylated hydroxytoluene (BHT) can be beneficially used in the subject lubricant to inhibit oxidation of the lubricant in the applicator prior to use.

The foaming lubricant of the invention is preferably applied using an aerosol device containing a propellant that assists in spraying the lubricant onto the desired surface. The propellant can be any known propellant used in aerosol devices that are appropriate for use in a food-grade lubricant, and is preferably a gaseous hydrocarbon component that is soluble in the triglyceride esters. Preferred propellants include, for example, butane, isobutane, and mixtures thereof, although similarly effective non-hydrocarbon propellants such as carbon dioxide, air, and mixtures thereof, can also be used if desired. A sufficient amount of propellant should be included to ensure there is enough pressure in the aerosol device to expel substantially all of the lubricant from the container. Typically from about 4 to about 15 weight percent is a sufficient amount of propellant for this purpose. The turbulence created by an aerosol applicator device will ensure that the lubricant foams when applied onto a machine component. If too little propellant is provided, the lubricant will not foam as it exits the container. If too much propellant is used, the foam will likely break as it is sprayed from the can. Even if an aerosol application device is not used to apply the lubricant, the lubricant will still foam to a lesser extent as a result of the normal movement of the components to which it is applied.

The complete compositions of representative foaming lubricants made in accordance with the invention are disclosed in the table below:

Table of Representative Compositions

| Ingredient | Composition (wt %) | | | | |
|---|---|---|---|---|---|
| palm methyl ester | 50 | | | 35 | |
| soy methyl ester | | | | | 5 |
| canola oil | | 70 | | | |
| canola oil AP-60 | 37 | | 35 | 35 | |
| corn oil | | | | | 87.3 |
| ethyl lactate | | 17 | | | |
| ethyl acetate | | | 17 | | |
| t-butyl acetate | | | | 17 | |
| lecithin | 8 | 8 | 8 | 8 | 2.2 |
| propellant | 5 | 5 | 5 | 5 | 4 |
| deodorized FAME | | | 35 | | |
| polysorbate | | | | | 0.5 |
| antioxidant (BHT) | | | | | 1 |
| specific gravity | 0.887 | 0.947 | 0.899 | 0.882 | 0.905 |

One of skill in the art will appreciate that these lubricants are created by mixing the components together by stirring in the same manner used to manufacture current food-grade lubricants. The foaming lubricants of the current invention are desirably used to lubricate various components on food processing and handling equipment, and in various regimes ranging from hydrodynamic thick films to boundary thin films.

The descriptions of the embodiments presented above are illustrative and are not intended to limit the scope of the invention. Other alterations and modifications of the preferred embodiments disclosed above will become apparent to those of ordinary skill in the art upon reading this disclosure, and it is intended that the scope of the invention disclosed herein be limited only by the broadest interpretation of the appended claims to which the inventor is legally entitled.

What is claimed is:

1. A foaming food-grade lubricant comprising blends of vegetable oil and triglyceride esters of C₈ to C₂₂ fatty acids derived from vegetable oil or animal products, compounded with lecithin, a propellant and, optionally, an organic solvent.

2. The foaming food-grade lubricant of claim 1 comprising from about 5 to about 50 weight percent triglyceride esters of C₈ to C₂₂ fatty acids.

3. The foaming food-grade lubricant of claim 1 wherein the triglyceride esters of C₈ to C₂₂ fatty acids are selected from the group consisting of methyl laurate, soy methyl ester and palm methyl ester.

4. The foaming food-grade lubricant of claim 1 comprising from about 30 to about 87 weight percent vegetable oil, animal products, or mixtures thereof.

5. The foaming food-grade lubricant of claim 1 wherein the vegetable oil is selected from the group consisting of canola oil, corn oil, castor oil, soybean oil, jojoba oil, safflower oil, sunflower oil and palm oil.

6. The foaming food-grade lubricant of claim 1, further comprising white oil.

7. The foaming food-grade lubricant of claim 1 wherein the animal products are selected from the group consisting of tallow oil, lard oil, sperm oil, and mixtures thereof.

8. The foaming food-grade lubricant of claim 1 comprising from about 2.2 to about 12 weight percent lecithin.

9. The foaming food-grade lubricant of claim 8 comprising about 8 weight percent lecithin.

10. The foaming food-grade lubricant of claim 1 comprising an organic solvent selected from the group consisting of short-chain esters of short chain carboxylic acids.

11. The foaming food-grade lubricant of claim 10 wherein the short-chain esters have fewer than 8 carbon atoms.

12. The foaming food-grade lubricant of claim 10 wherein the organic solvent is selected from the group consisting of ethyl lactate, ethyl acetate and t-butyl acetate.

13. The foaming food-grade lubricant of claim 1 comprising from about 10 to about 20 weight percent organic solvent.

14. The foaming food-grade lubricant of claim 13 comprising from about 15 to about 17 weight percent organic solvent.

15. The foaming food-grade lubricant of claim 1 wherein the propellant is a gaseous hydrocarbon component that is soluble in the triglyceride esters.

16. The foaming food-grade lubricant of claim 15 wherein the propellant is selected from the group consisting of butane, iso-butane, and mixtures thereof.

17. The foaming food-grade lubricant of claim 1 wherein the propellant is carbon dioxide.

18. The foaming food-grade lubricant of claim 1 comprising from about 4 to about 15 weight percent propellant.

19. The foaming food-grade lubricant of claim 1 further comprising a minor effective amount up to about 1 weight percent of an antioxidant.

20. The foaming food-grade lubricant of claim 19 wherein the antioxidant is butylated hydroxytoluene.

21. The foaming food-grade lubricant of claim 1 further comprising a minor effective amount up to about 1 weight percent of a surfactant.

22. The foaming food-grade lubricant of claim 21 wherein the surfactant is a polysorbate.
